(19) United States
(12) Patent Application Publication
(10) Pub. No.: US 2009/0324862 A1
(43) Pub. Date: Dec. 31, 2009

(54) HOCKEY STICK BLADE SLEEVE

(76) Inventor: Garth Wells, Vernon (CA)

Correspondence Address: Richard D. Okimaw, 210-347 Leon Avenue, Kelowna, BC, V1Y8C7, CA

(21) Appl. No.: 12/448,849

(22) PCT Filed: Jan. 10, 2008
(86) PCT No.: PCT/CA2008/000075

§ 371 Date: Jul. 10, 2009

Related U.S. Application Data
(60) Provisional application No. 60/880,329, filed on Jan. 12, 2007.

(51) Int. Cl. B32B 37/12

(52) U.S. Cl. 428/35.2; 156/303.1

(57) ABSTRACT

Disclosed is a method and apparatus for covering the blade of a hockey stick. The blade has an exterior surface and a cross sectional area. The apparatus comprises a sleeve having first and second ends and an inner surface and an outer surface. The inner surface defines a cavity wherein the cavity has a cross sectional area which is less than the cross sectional area of the blade. The inner surface of the sleeve has an adhesive material thereon. The method comprises sliding the sleeve over the hockey blade and applying heat to the sleeve sufficient to melt the adhesive material so as to adhere the inner surface of the sleeve to the outer surface of the blade.

### FIELD OF THE INVENTION

The present invention relates to attachments for hockey stick blades in general, and more particularly to a sleeve adapted to surround the blade to protect the blade and help the player to control the puck.

### BACKGROUND OF THE INVENTION

Hockey players at all levels of competition commonly cover their hockey stick blades with a slightly overlapping strip of hockey tape wound continuously around the blade. The main reasons a player has for doing this are to reinforce and protect the blade from wear due to contact with the puck and playing surface, and to increase the amount of control he has over the puck.

A common problem experienced by ice hockey players is the infiltration of water into the tape layers, causing the tape to loosen off of the blade, and in some cases causing the hockey stick to become unbalanced. In addition, the hockey tape tends to unravel, wear out and become frayed, requiring the user to frequently rewrap the blade. In order to prevent the infiltration of water into the hockey tape, a thin layer of wax is sometimes applied to the outside surface of the tape. However, this process is time-consuming, and the presence of moisture on the wax causes the blade to become slippery, reducing the amount of puck control the user has.

Accordingly, a number of solutions have been developed that address the problems associated with the use of hockey tape on the puck-contacting surface of hockey sticks. These solutions generally comprise single-piece tubular sleeves that slide onto the hockey stick blade. Applicant is aware of patents regarding such examples, including:

U.S. Patent Application Publication Number 2002/0177497 titled “Article of Manufacture and Method for Improving Handling and Performance of Sports Equipment and for Advertising Thereon” by Ulf Anders Paulson Westerlund and published on Nov. 28, 2002 discloses a sleeve for placement over an ice or hockey stick. The front surface of the sleeve may have a patterned surface to improve the contact between the blade and the puck. The front surface can also act as an information display area for advertising sponsors, teams logos, or other information. Although the device of Westerlund may be made of an elastic material, Westerlund does not teach that the sleeve must be in an interference fit with the blade of the hockey stick such that the sleeve must be stretched to be placed over the blade. The sleeve of Westerlund also does not include an adhesive and therefore, the sleeve could potentially shift on the blade or even slide off during use.

U.S. Pat. No. 6,273,835 titled “Hockey Stick Blade Sleeve” issued to Battis et al. on Aug. 14, 2001, teaches a hockey stick blade sleeve. The sleeve of Battis et al. comprises an elastomeric coated fiber-weave sleeve that is retained on the hockey stick blade by the stretch of the material. Battis et al. teaches that an adhesive or bonding agent is not necessary between the sleeve and the blade. However, lack of such an adhesive along with the fabric internal wall of the sleeve may provide a low-friction contact surface with the hockey stick blade. This may potentially causing the sleeve to shift on the blade, or even slide off of the blade during game play.

U.S. Pat. No. 5,558,326 titled “Hockey Stick Blade Cover and Method” issued to Adamson et al. on Sep. 24, 1996 discloses a tubular, heat-shrinkable film cover member for application to a hockey stick blade. The film, which is open-ended, initially has internal dimensions larger than the external dimensions of a hockey stick blade. After the sleeve has been placed on the hockey stick blade, a heat source is used to heat the sleeve, causing it to shrink until it is tightly stretched around the blade. The sleeve may contain a thickened, textured puck-contacting surface to improve the contact between the blade and the puck. A disadvantage of applying heat-shrinkable tubing to a hockey stick blade is that uneven heating can cause the sleeve to wrinkle, resulting in an uneven surface on the puck-contacting surface of the blade. Such a sleeve may also be difficult to remove from the blade when a new sleeve is desired.

U.S. Pat. No. 4,148,482 titled “Hockey Stick Reinforcing Method and Product” issued to Harwell, Jr. et al. on Apr. 10, 1979, teaches a continuous length of textile tubing that can be cut to the appropriate length for application onto the blade of a hockey stick. The textile is a wear-resistance material such as fiberglass or polyester. After the sleeve has been cut to length, the tip is tied together to form a closed sock, and the sleeve is slid onto the blade. The construction of the sleeve is such that pulling on it in the longitudinal direction causes its diameter to decrease. Once the sleeve has been located on the hockey stick blade, a resinous coating is applied to the sleeve and allowed to cure. The sleeve is designed to reinforce the blade, and does not contain means to improve the user's puck control. The device of Harwell, Jr. et al. is not well adapted to be used to retrofit a hockey stick as removal of such a device would be difficult. Resinous coatings are also undesirable due the difficulty and mess of working with such a material.

### SUMMARY OF THE INVENTION

According to a first embodiment of the present invention there is disclosed an apparatus for covering the blade of a hockey stick. The blade has an exterior surface and a cross sectional area. The apparatus comprises a sleeve having first and second ends and an inner surface and an outer surface. The inner surface defines a cavity wherein the cavity has a cross sectional area which is less than the cross sectional area of the blade. The inner surface of the sleeve has an adhesive material thereon.

The adhesive material may comprise a thermoplastic adhesive. The thermoplastic adhesive may have a melting point between 110 and 150 degrees Fahrenheit.

The sleeve may be formed of a flexible material. The flexible material may be elastic. The flexible material may be selected from the group consisting of plastic, rubber, silicone, latex, elastomer or fabric.

The sleeve may include perforations for transmitting heat from the outer surface of the sleeve to the inner surface of the sleeve. The sleeve may have a wall thickness between the inner and outer surfaces of between 10 and 100 thousands of an inch.

The cavity may be substantially rectangular. The said cavity may include opposed actuate ends. The arcuate ends may span between opposed first and side walls of the sleeve.

The first side wall may have a puck contacting exterior surface. The exterior puck contacting surface may be semi-adhesive. The puck contacting exterior surface may be adapted to frictionally engage a puck. The puck contacting exterior surface may be formed from a contact material selected from the group consisting of rubber, silicone, latex or elastomers.

The apparatus may further comprise an end cap enclosing the second end of the sleeve wherein the first end of the sleeve has an opening adapted to receive the blade of the hockey stick.

According to a further embodiment of the present invention there is disclosed a sleeve for selectably covering an object having an exterior surface and a cross sectional area. The sleeve has first and second ends and inner and outer surfaces. The inner surface defines a cavity wherein the cavity has a cross sectional area which is less than the cross sectional area of the object. The inner surface of the sleeve has an adhesive material thereon.

According to a further embodiment of the present invention there is disclosed a method of covering the blade of a hockey stick. The blade has an exterior surface and a cross sectional area. The method comprises providing a sleeve having inner and outer surfaces. The inner surface defines a cavity wherein the cavity has a cross sectional area which is less than the cross sectional area of the blade. The inner surface of the sleeve has an adhesive material thereon. The method further comprises sliding the sleeve over the hockey blade and applying heat to the sleeve sufficient to melt the adhesive material so as to adhere the inner surface of the sleeve to the outer surface of the blade.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a hockey stick having a sleeve according to a first embodiment of the present invention applied to its blade.

FIG. 2 is a detailed perspective view of the sleeve of FIG. 1 applied to a hockey stick blade.

FIG. 3 is a perspective view of a sleeve according to a further embodiment of the present invention having opposed open ends.

FIG. 4 is a cross-sectional view of the sleeve of FIG. 3 taken along the line 4-4.

FIG. 5a is a cross-sectional view of the sleeve of FIG. 3 showing a rectangular end top wall according to a further embodiment of the present invention.

FIG. 5b is a cross-sectional view of the sleeve of FIG. 3 showing a peaked end top wall according to a further embodiment of the present invention.

FIG. 6 is a perspective view of a sleeve of FIG. 1 having an advertising or logo receiving surface according to a further embodiment of the present invention.

FIG. 7 is a perspective view of the sleeve of FIG. 3 being slidably applied to the blade of a hockey stick.

FIG. 8 is a perspective view of the sleeve of FIG. 3 applied to the blade of a hockey stick and having a heat source applied thereto to melt the adhesive.

### DETAILED DESCRIPTION OF EMBODIMENTS OF THE INVENTION

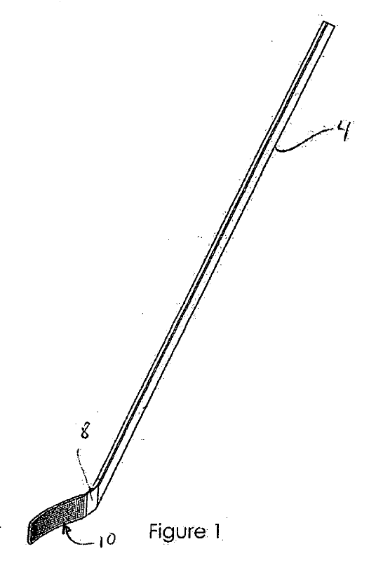

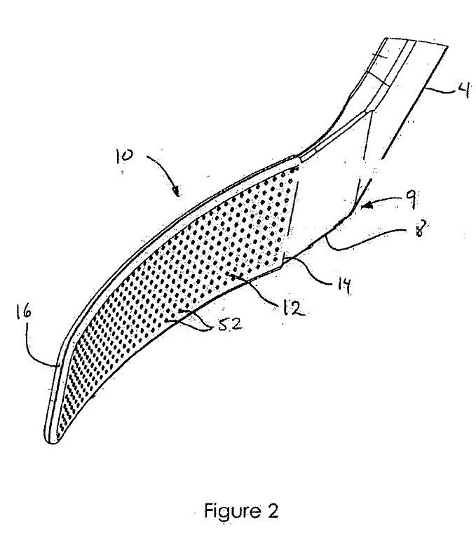

Referring to FIG. 1, a sleeve according to a first embodiment of the invention is shown applied to the blade 8 of a hockey stick 4 generally at 10. The sleeve 10 comprises an elongate tubular member having a cross section adapted to closely engage the blade 8 and a puck engaging surface 12. The sleeve has an open end 14 and may optionally have an opposed closed end 16 as illustrated in FIG. 2.

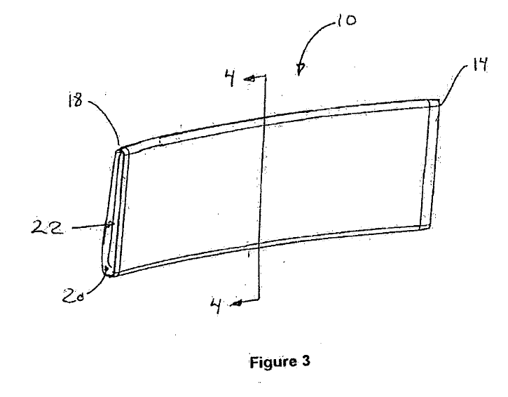

Turning now to FIG. 3, a sleeve 10 having first and second opposed open ends 14 and 18, respectively is illustrated. The sleeve 10 has an inner surface 20 defining an inner passage 22 therethrough. The distance between the first and second ends 14 and 18 is sufficient to permit the sleeve 10 to cover substantially the length of the blade 8. It will be appreciated that for embodiments having a closed end as illustrated in FIG. 2, the passage 22 will be a blind cavity having a closed end 16. In such embodiments, the distance between the open and closed ends 14 and 18 may be approximately 11 inches or longer so as to extend over a portion of the heal 9 of the blade 8. It will be appreciated that the closed end 18 of the sleeve may be cut off by a user to adapt a closed end sleeve to an open end sleeve. The inner passage 22 has a circumference selected to be less than the circumference of a typical hockey stick blade 8. The selection of the dimensions of the inner passage 22 to have a circumference less than the circumference of a desired hockey stick blade will ensure that there is a compression or interference fit between the sleeve and the hockey stick blade. The compression or interference fit will assist in retaining the sleeve on the blade.

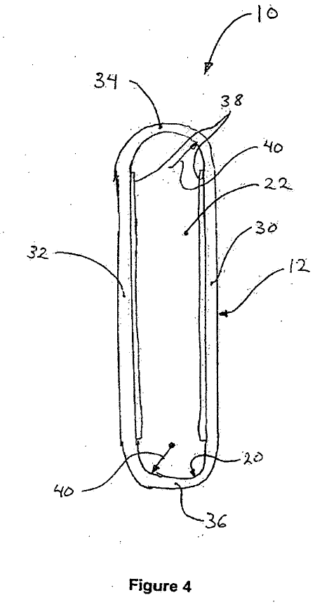

The sleeve 10 has a generally rectangular cross-section as illustrated in FIG. 4. The sleeve 10 has opposed front and back walls 30 and 32, respectively and top and bottom end walls 34 and 36, respectively. The front, back, top and bottom walls 30, 32, 34 and 36 are continuous with each other in an endless loop extending between the first and second ends 14 and 18. The top and bottom walls 34 and 36 have a radiused profile extending between the front and back walls 30 and 32. As illustrated, the top and bottom walls 34 and 36 may have a continuous curvature between the front and back walls 30 and 32. The curvature of the top and bottom walls 34 and 36 may have a radius generally shown at 40. The radius 40 is equal to approximately double the thickness of a typical hockey stick blade 8. The radius 40 will according to some embodiments be approximately between ⅛ and 1/16 of an inch. It will be appreciated however, that the radius may be less than double the thickness of a typical hockey blade 8. In particular it has been found that a radius of approximately between 3/32 and 1/16 inches is particularly useful. It will also be appreciated that the radius 40 may need to be enlarged for a portion of the sleeve 10 to cover the heel 9 of the blade for some embodiments.

According to a preferred embodiment of the present invention, a front and back wall 30 and 32 have a height of approximately ⅜ inches less than the height of the blade 8. It will be appreciated that for materials having a higher modulus of elasticity less of difference between the front and back walls 30 and 32 and the blade 8 will be necessary. What is required is that the height of the front and back walls 30 and 32 be less than the height of the blade 8. According to an optional embodiment of the present invention, the height of the sleeve 10 may be reduced proximate to the first end 14 adapted to surround the heel 9 of the blade 8. This will permit the sleeve 10 to be maintained in compression fitting around the whole of the blade 8.

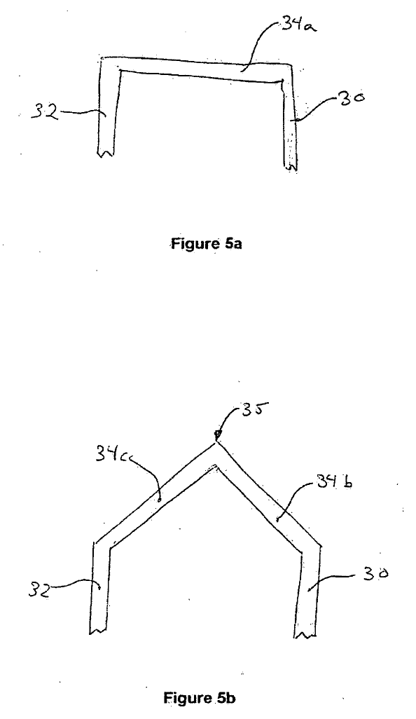

It will be appreciated however that other profiles for the top and bottom walls 34 and 36 may also be useful as well. With reference to the illustrated top wall in FIGS. 5a and 5b, and by way of non-limiting example, the top and bottom walls 34 and 36 may have a rectangular profile wherein the top and bottom walls comprise a substantially planar wall 34a connected to the front and back walls 30 and 34 at substantially right angles as illustrated in FIG. 5a. The top and bottom walls 34 and 36 may also be formed of a pair of angled walls 34b and 34c extending from the front and back walls 30 and 32 and connected together at a crease or ridge 35 as illustrated in FIG. 5b.

The sleeve 10 has a continuous inner surface 20 as previously described above. The inner surfaces 20 of the front and back walls 30 and 32 have a layer 38 of adhesive applied thereto as further discussed below. It will be appreciated that the inner surfaces 20 of the top and bottom walls may optionally also have a layer of adhesive applied thereto. The thickness of the front and back walls 30 and 32 as well as the top and bottom walls 34 and 36 is selected to correspond approximately to the thickness of one to three layers of hockey tape. In practice, a thickness of approximately between 0.010 and 0.200 inch has been found to be sufficient. According to a preferred embodiment of the present invention, a thickness of approximately 0.010 to 0.030 inch has been particularly useful. It will be appreciated that different thicknesses may be preferred by the user. Some users may prefer a thicker sleeve to provide extra cushioning between the hockey stick blade and puck whereas other users may prefer a thinner sleeve to provide more “feel” or to transmit more information regarding the contact between the puck and the blade to the user.

The properties of the puck engaging surface 12 of the sleeve 10 may be adapted to suit the preferences of the user. The puck engaging surface 12 may be smooth, rough, tacky, or can contain features such as textures or patterned nubs. It will be appreciated that the degree of these features may be adapted to suite the preferences of the user as well. In particular, a tacky puck engaging surface 12 may be useful for increasing surface friction between the puck engaging surface 12 and a puck (not shown) to provide better control of the puck. In addition a textured or cross-hatched puck engaging surface 12 may also assist in puck control or moisture dissipation from the puck engaging surface 12.

The sleeve 10 may be constructed of a flexible elastic material. The sleeve must have sufficient elasticity to be stretched by the difference between the circumference of the inner passage 22 and the circumference of the hockey blade 8. The sleeve must also have stable properties at the temperatures experienced by a hockey blade and during the application process of the sleeve. In particular, the material selected for the sleeve must have sufficiently stable properties between the temperatures of −20 and 500 degrees Fahrenheit such that the elasticity, brittleness and durability of the material is not adversely affected within these temperature ranges. The sleeve must also be capable of conducting sufficient heat from the exterior of the sleeve to the inner passage to melt the adhesive 38 as discussed in greater detail below. Desirably, the material will have sufficient toughness or abrasion resistance so as to withstand repeated contact between the sleeve and a playing surface or puck. In practice, it has been found that various types of natural organic and synthetic rubber may be adequate. Silicones and various plastics have also been found to be useful. Various elastomers and vinyls have also been found to be useful. In addition, it will be appreciated by those of skill in the art that ceramics and composite materials may also be useful. According to an alternative embodiment of the present invention, the sleeve may be formed with a plurality of apertures 52 through the walls of the sleeve to permit heat transfer therethrough as illustrated in FIG. 2.

The sleeve 10 of the present invention may be constructed from various methods as are known in the art. In particular, it has been found that various types of molding may be useful, such as, by way of non-limiting example dip molding, injection molding or blow molding. It will be appreciated that other methods of constructing the present sleeve may also be useful as well. By way of non-limiting example, the sleeve 10 could be constructed woven or non-woven fabric, mesh. It will also be appreciated that combinations of these types of construction methods may be combined together to form a sandwiched or impregnated material.

The layer of adhesive 38 is comprised of a hot melt type adhesive of a type known to those of skill in adhesives. The hot melt adhesive is selected to have melting temperature in a range of a standard heat gun. In practice, a melting temperature of between 100 and 300 degrees Fahrenheit has been found to be suitable. In particular, a melting temperature of between 110 and 150 degrees Fahrenheit has been found to be particularly useful. The adhesive should also remain flexible when dry at the normal operating temperatures of a hockey stick as discussed above. The adhesive may be sprayed or rolled on to the sleeve. It will be appreciated that the sleeve may be turned inside out to facilitate application of the adhesive. The adhesive may preferably be resistant to shock when dry so as to not crack or break during use of the hockey stick. The adhesive should be selected to be dry, not tacky and to have a low friction surface at room temperatures so as to facilitate application of the sleeve 10 to the blade 8. In practice a thickness of 0.003 to 0.005 inch has been found to be useful for the layer of adhesive although those of skill in the art will appreciate that other thicknesses may be useful as well.

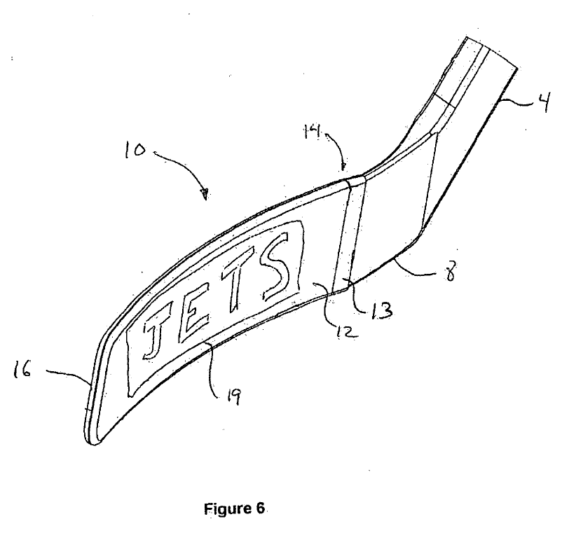

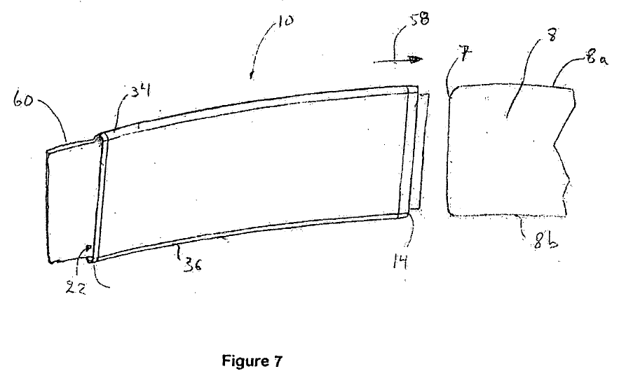

Referring to FIG. 6, an alternative embodiment of the sleeve 10 is illustrated. The sleeve 10 may have a have a closed end 16 and an open end 14 as discussed above. The open end 14 may include a taper 13 to give the sleeve a more aesthetic appearance. The taper 13 may also assist in providing a uniform puck contacting surface by blending the edge of the sleeve 10 to the hockey stick blade 8. It will be appreciated that other edge profiles will also be useful as well, such as rounded, squared or chamfered. A logo 19 or other indication may be applied to the front puck contacting surface 12. It will be appreciated that the logo 19 may need to be scaled in the vertical direction when applied to a sleeve 10 that has not been stretched for application to the blade 8 such that the logo 19 has a dimensionally correct appearance when the sleeve is stretched over the blade. In some embodiments, the sleeve may stretch uniformly around the blade and therefore the logo 19 should be correspondingly uniformly scaled. In other embodiments, the sleeve 10 may be adapted to stretch more at the portions closer to the top and bottom walls 34 and 36. In these embodiments, the logo should be correspondingly scaled to a greater degree closer to these top and bottom walls 34 and 36.

In operation, the sleeve 10 may be applied to the blade 8 of a hockey stick by sliding the open end 14 of the sleeve over a free distal end 7 of the blade in a direction generally indicated at 58. The top and bottom walls 34 and 36 of the sleeve 10 may be aligned with corresponding top and bottom edges 8a and 8b, respectively of the blade 8. The elasticity of the sleeve 10 will permit the sleeve to stretch over the blade 8 and thereafter maintain a secure fitting thereon. The sleeve is preferably applied to the blade at room temperature at which the adhesive is dry and slippery such that the adhesive reduces the friction between the blade and the sleeve so as to assist sliding the sleeve over the blade. An insert 60 may optionally be included within the inner passage 22 of the sleeve 10. The insert may be included with the sleeve for storage to prevent opposed portions of the inner surface 20 from touching and adhering to itself during storage. The insert 60 may also include a low coefficient of friction surface so as to assist the application of the sleeve 10 to the blade 8. After the sleeve 10 has been applied to the blade 8 the optional insert 60 may be slidably removed therefrom.

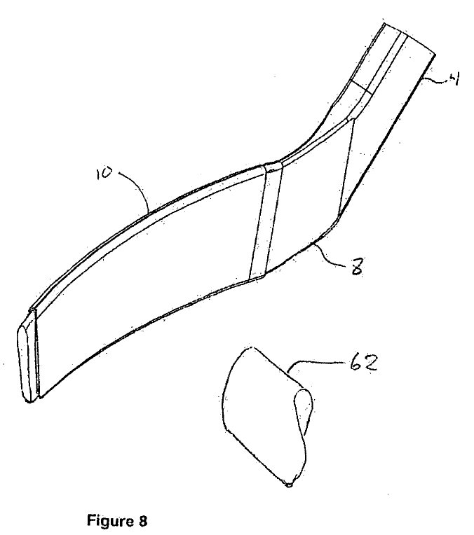

Once the sleeve 10 is applied to the blade 8, a heat gun 62 or other heating source may be utilized to melt the adhesive to the melting temperature discussed above as illustrated in FIG. 8. The heat gun 62 heats the adhesive to its melting point so as to adhere the sleeve 10 to the blade 8.

The sleeve 10 of the present invention may be removed from the blade 8 by applying heat with a heat gun 62 or other suitable means so as to heat the adhesive above it's melting point. The sleeve 10 may then be slidably removed or cut from the blade 8. Thereafter any remaining adhesive may be removed from the blade 8 by conventional means and a new sleeve 10 applied as desired by the user.

According to an alternative embodiment of the present invention, the sleeve 10 may be provided without the layer of adhesive 38 applied thereto. A thin film of adhesive may be applied to the blade 8 of the hockey stick. Thereafter, the sleeve 10 may be slidably applied to the blade 8 over the film of adhesive. A heat gun 62 or other heat source may then be used to melt the adhesive. It will be appreciated that a lubricant or anti-friction powder may also be useful for applying the sleeve 10 to the blade 8.

While specific embodiments of the invention have been described and illustrated, such embodiments should be considered illustrative of the invention only and not as limiting the invention as construed in accordance with the accompanying claims.

What is claimed is:

1. An apparatus for covering the blade of a hockey stick, the blade having an exterior surface and a cross sectional area, the apparatus comprising a sleeve having first and second ends and an inner surface and an outer surface, said inner surface defining a cavity wherein said cavity has a cross sectional area which is less than the cross sectional area of the said blade, said inner surface of said sleeve having an adhesive material thereon.

2. The apparatus of claim 1 wherein said adhesive material comprises a thermoplastic adhesive.

3. The apparatus of claim 2 wherein said thermoplastic adhesive has a melting temperature between 110 and 150 degrees Fahrenheit.

4. The apparatus of claim 1 wherein said sleeve is formed of a flexible material.

5. The apparatus of claim 4 wherein said flexible material is elastic.

6. The apparatus of claim 4 wherein said flexible material is selected from the group consisting of plastic, rubber, silicone, latex, elastomer or fabric.

7. The apparatus of claim 1 wherein said sleeve includes perforations for transmitting heat from said outer surface of said sleeve to said inner surface of said sleeve.

8. The apparatus of claim 1 wherein said sleeve has a wall thickness between said inner and outer surfaces of between 10 and 100 thousands of an inch.

9. The apparatus of claim 1 wherein said cavity is substantially rectangular.

10. The apparatus of claim 9 wherein said cavity includes opposed arcuate ends.

11. The apparatus of claim 10 wherein said arcuate ends span between opposed first and side walls of said sleeve.

12. The apparatus of claim 11 wherein said first side wall has a puck contacting exterior surface.

13. The apparatus of claim 12 wherein said puck contacting exterior surface is semi-adhesive.

14. The apparatus of claim 12 wherein said puck contacting exterior surface is adapted to frictionally engage a puck.

15. The apparatus of claim 14 wherein said puck contacting exterior surface is formed from a contact material selected from the group consisting of rubber, silicone, latex or elastomers.

16. The apparatus of claim 1 further comprising an end cap enclosing said second end of said sleeve wherein said first end of said sleeve has an opening adapted to receive the blade of the hockey stick.

17. A sleeve for selectably covering the an object having an exterior surface and a cross sectional area, the sleeve having first and second ends and inner and outer surfaces, said inner surface defining a cavity wherein said cavity has a cross sectional area which is less than the cross sectional area of said object, said inner surface of said sleeve having an adhesive material thereon.

18. A method of covering the blade of a hockey stick, the blade having an exterior surface and a cross sectional area, the method comprising:
providing a sleeve having an inner surface and an outer surface, said inner surface defining a cavity wherein said cavity has a cross sectional area which is less than the cross sectional area of said blade, said inner surface of said sleeve having an adhesive material thereon;
sliding said sleeve over the hockey blade; and
applying heat to said sleeve sufficient to melt said adhesive material so as to adhere said inner surface of said sleeve to the outer surface of the blade.
